(19) United States
(12) Patent Application Publication
(10) Pub. No.: US 2019/0333726 A1
(43) Pub. Date: Oct. 31, 2019

(54) SIGNAL DEVICE FOR SWITCH

(71) Applicant: Schneider Electric (Australia) Pty Ltd, Macquarie Park (AU)

(72) Inventors: Fuhua SHAN, Shenzhen (CN); Zhuomin DENG, Shenzhen (CN)

(73) Assignee: Schneider Electric (Australia) Pty Ltd, Macquarie Park (AU)

(21) Appl. No.: 16/393,015

(22) Filed: Apr. 24, 2019

(30) Foreign Application Priority Data
Apr. 28, 2018 (CN) 201820636263.5

(51) Int. Cl. H01H 47/00

(52) U.S. Cl. CPC H01H 47/00; H05B 37/0272

(57) ABSTRACT

Embodiments of the present disclosure relate to a signal device for a switch. The signal device comprises: a signal transmitter disposed separately from the switch and configured to transmit a signal in response to a trigger; and a signal receiver detachably coupled to the switch and configured to control an operation of the switch in response to the signal transmitted by the signal transmitter.

### FIELD

Embodiments of the present disclosure relate to an electronic switch, and more specifically to a signal device for the switch.

### BACKGROUND

Usually, a user may activate an electronic switch by for example touching a panel of an electronic-type switch. A more intelligent way for activating the switch is to trigger the operation of the electronic-type switch with for example a remote signal, thereby controlling its load, such as a lighting device, to function as desired by the user, for example, turning on the lighting device, adjusting the illumination intensity of the lighting device, etc.

Among commercially available products at present, there are no user-friendly products that can control the operation of electronic-type switch in a convenient manner.

### SUMMARY

Embodiments of the present disclosure provide an improved signal device for a switch, to address at least some of current problems mentioned above.

An aspect of the present disclosure provides a signal device for a switch. The signal device comprises: a signal transmitter disposed separately from the switch and configured to transmit a signal in response to a trigger; and a signal receiver detachably coupled to the switch and configured to control an operation of the switch in response to the signal transmitted by the signal transmitter.

The signal device for the switch according to embodiments of the present disclosure has a lot of advantages, such as having no impact on the implementation of other components of the switch, operating flexibly, updating easily, and having large room for the updating.

In some embodiments, a button or knob may be provided on the signal transmitter, and the signal transmitter may be configured to transmit the signal in response to the button or knob being operated.

In some embodiments, at least one surface of the signal transmitter may comprise a touch-sensitive surface, and the signal transmitter can be configured to transmit the signal in response to the touch-sensitive surface being touched.

In some embodiments, the signal transmitter may be provided with at least one of the following to sense the trigger: a sound sensor, an optical sensor, a microwave sensor, a temperature sensor, a humidity sensor, a gas sensor, a touch sensor, a fingerprint recognition sensor, a voice recognition sensor and a camera.

In some embodiments, the optical sensor may be an infrared sensor.

In some embodiments, the signal receiver may be communicatively coupled to the switch via a standard USB interface formed on the switch.

Another aspect of the present disclosure provides a switch comprising a control module assembly and the signal device according to any of the foregoing embodiments.

### BRIEF DESCRIPTION OF THE DRAWINGS

The above and other objects, features and advantages of the embodiments of the present disclosure will become more apparent through the following detailed description with reference to figures which are drawn not necessarily in a scale. In the figures, a plurality of embodiments of the present disclosure are described in an exemplary and non-restrictive manner, wherein:

FIG. 1 schematically illustrates a signal device for a switch according to an embodiment of the present disclosure;

FIG. 2 schematically illustrates the signal device of FIG. 1 and a control module assembly for the switch;

FIG. 3 schematically illustrates the signal device of FIG. 1 and a control module assembly for the switch;

FIG. 4 schematically illustrates the signal device of FIG. 1 and a control module assembly for the switch; and

FIG. 5 illustrates a schematic exploded view of a control module assembly according to an embodiment of the present disclosure.

### DETAILED DESCRIPTION

The concept and configuration of the present disclosure will now be described with reference to various exemplary embodiments illustrated in the figures. When corresponding embodiments or examples are described with reference to figures, terms related to directions such as “up”, “down”, “vertical”, “horizontal (transverse)”, “top (portion)” and “bottom (portion)” are used to facilitate understanding of depictions of the present disclosure, they are either based on directions presented when the reader observes views or based on a normal use direction of the product itself, and they do not impose undesired limitations to the extent of protection of the present disclosure.

Regarding how to control intelligent electronic switches, existing products basically focus on the following design manners:

One manner is to construct a signal transmitter, a signal receiver and power supply control of the switch together as a whole. This design causes complicated circuit wiring of the switch and inevitably makes the signal transmission and reception severely restricted by the limited space adapted for mounting the switch, thereby affecting the user friendliness of the switch.

Another manner is that although the signal transmitter and the signal receiver are designed to be independent from each other in space, the signal receiver and the power supply control of the switch are still constructed as a whole because of constraints of the conventional design idea. In this case, if either of the power supply terminal or signal receiver terminal of the switch is faulty or damaged, the entire switch will consequently fail. Another drawback of this type of design is that when the signal transmitter terminal is faulty or damaged, or the mode of operation of the signal transmitter needs to be changed, there will be a problem that the original signal receiver cannot match a replaced signal transmitter due to the different signal reception protocols.

A further manner is that at least one of the signal transmitter and the signal receiver of the switch is disposed outside the switch body and then coupled to the power supply control device in a wired connection manner for signal transmitting. Compared with the aforementioned design manner in which all of the signal transmitter, signal receiver and power supply control of the switch are arranged in the same space, this type of design manner is improved; however, it is still constrained by the limited mounting space due to the conventional wired connection manner.

A further manner is to build a signal receiving module or signal receiver in the switch and use a smart device, especially a mobile phone, to control the transmitted signal. One of the drawbacks of this type of design is that, if the signal receiving device fails due to a fault or the like, the switch product will accordingly be scrapped. A further drawback is that, since the signal transceiving protocol is already fixed, the operation of the switch might be affected by for example the interference from communication protocols utilized by other electronic products which are in the same room and utilize the same transmission protocol.

Embodiments of the present disclosure provide an improved signal device for a switch, and particularly improve electronic-type smart switches.

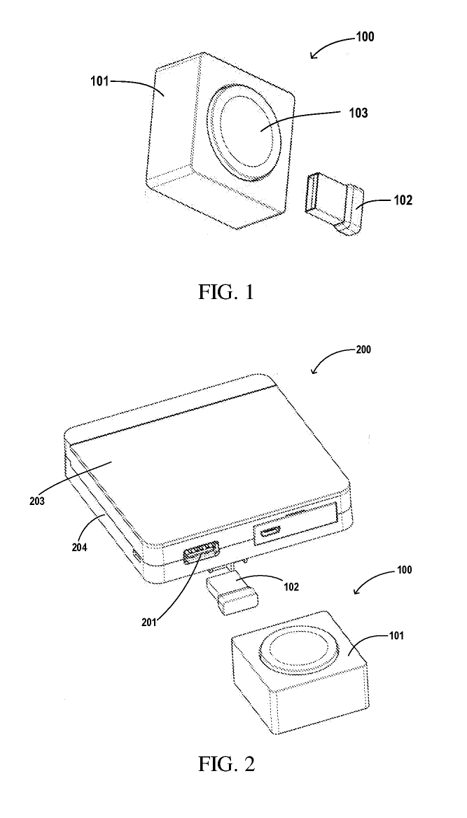

According to the embodiment shown in FIG. 1 of the present disclosure, a signal device 100 for a switch includes: a signal transmitter 101 disposed separately from the switch and configured to transmit a signal in response to a trigger; and a signal receiver 102 detachably coupled to the switch and configured to control an operation of the switch in response to the signal transmitted by the signal transmitter 101.

Two core parts of the signal device shown in FIG. 1 are the signal transmitter 101 and the signal receiver 102, which are spatially separated from each other and independent of each other.

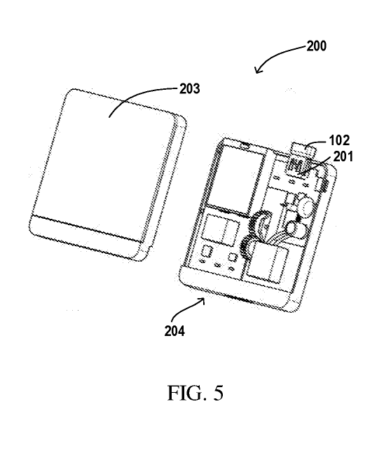

The signal receiver 102 can be mounted to the switch, more specifically to a control module assembly 200 thereof, in a detachable or pluggable manner, as shown in FIG. 4 and FIG. 5.

The signal transmitter 101 may be spatially separated and independent from the signal receiver 102, and may be arranged separately from the switch body, even at a large distance from the switch body. For example, the switch may be installed in a room of a building, and the signal transmitter 101 may be installed at an entrance to the building remote from the room, so long as it can be ensured that the signal transmitter 101 is in an effective range in which the signal receiver 102 can accurately receive the signal emitted by the signal transmitter.

Referring to FIG. 1, on the signal transmitter 101, for example, in its surface facing the user, a button or knob 103 is provided. The signal transmitter 101 may emit a signal in response to the operation of the button or knob 103. For example, when the user presses the button or rotates the knob, the signal transmitter 101 is triggered. Then, the signal transmitter 101 makes a response upon detecting such operation of the user so as to transmit a signal for controlling the operation of the switch to the signal receiver 102.

In an example, at least one surface of the signal transmitter 101, for example, a surface that faces the user during the operation, includes a touch-sensitive surface. The signal transmitter 101 is capable of transmitting the signal to the signal receiver 102 in response to the user's touch on the touch-sensitive surface.

According to an embodiment of the present disclosure, in order to detect a trigger initiated by the user, the signal transmitter 101 may be provided with at least one of the following: a sound sensor, an optical sensor, a microwave sensor, a temperature sensor, a humidity sensor, a gas sensor, a touch sensor, a fingerprint recognition sensor, a voice recognition sensor and a camera. It will be appreciated that means provided in the signal transmitter 101 for detecting the trigger initiated by the user is not limited to the specific forms mentioned herein, but includes various suitable sensors or sensing devices which have already been implemented so far or would be developed in the future, so long as they are capable of detecting or sensing the user's trigger acting on the signal transmitter 101.

Therefore, the signal transmitter 101 can utilize various sensing designs and the signal device can realize flexible upgrade and replacement, thus providing a broad product design space, greatly enhancing the user's experience in use and bringing about enhanced user satisfaction.

In an example, the optical sensor may be an infrared sensor. For example, when the user stands at the entrance to the building or the room, the user blocks at least a portion of the signal transmitter 101, or the heat of the ambient environment changes, such that the signal transmitter 101 detects the trigger initiated by the user and thereby transmits a signal for controlling the operation of the switch to the signal receiver 102.

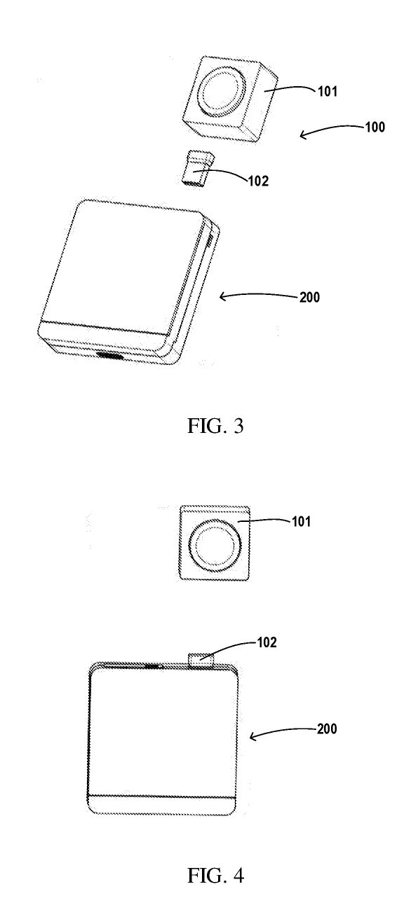

Referring to FIG. 2 to FIG. 5, a plug interface 201 is formed on the control module assembly 200 of the switch, for example, in its frame. The signal receiver 102 may be mounted in the plug interface 201 in a detachable or pluggable manner so as to communicatively couple with the switch or its control module assembly 200. In an example, the plug interface 201 is a standard USB interface. The standard USB interface is only presented as a specific form of the plug interface 201. The plug interface 201 is not limited to this specific form and includes various suitable plug interface types which have already been implemented so far or would be developed in the future, so long as they are capable of coupling to the signal receiver 102 in a detachable or pluggable manner.

It may be appreciated that embodiments of the present disclosure propose a solution to the technical problem existing in the existing switch signal device based on the following technical concept: the control module assembly 200, the signal transmitter 101 and the signal receiver 102 of the switch are spatially separate and independent from one another, and the signal receiver 102 is mechanically and communicatively coupled to the control module assembly 200 in a detachable, pluggable and replaceable manner, for example by means of a standard USB interface.

The signal device according to embodiments of the present disclosure has various advantages including but not limited to:

Firstly, the design of the circuit wiring of the switch is no longer restricted by the requirement that the signal transmitter 101 and the signal receiver 102 are arranged in the same confined space, for example, in the control module assembly 200. As a consequence, the internal space that is otherwise occupied by the signal device is saved, and, due to the save of the space, larger flexibility and selectivity of the internal layout of the control module assembly 200 can be achieved.

Secondly, when the switch needs to be upgraded or replaced, it is only necessary to remove the signal receiver 2 from the control module assembly 200 of the switch for upgrading or replacing without disassembling the control module assembly 200. Thus, there is no impact on any existing arrangement in the control module assembly 200, such as the power supply control.

Thirdly, the signal device can be replaced as a whole. The signal receiver 102 can be installed on another switch in such a way that the operation of said another switch can be controlled via the signal transmitter 101 communicatively coupled to the signal receiver 102.

For example, the switch is originally configured with a voice-activated signal device, that is, the signal transmitter 101 is used to detect a sound or changes of sound emitted by the user and then transmit a signal to the signal receiver 102. If the user desires to change the voice-activated trigger of the switch to an indoor temperature-changing-activated trigger, the user only needs to replace the signal device with a temperature-controlled type signal device, i.e., replace the signal transmitter 101 with a signal transmitter that is capable of detecting an indoor temperature or changes thereof and accordingly transmitting a signal.

Fourthly, since more and more different types of electronic products (such as notebook computers which transmit information via WIFI or Bluetooth) are simultaneously placed in a common space, for example, in the same room, so that there are more and more corresponding signal transmission protocols. Thus, a general protocol between the signal transceiving portions is vulnerable to the interference from other electrical or electronic products. Therefore, according to an embodiment of the present disclosure, the signal transmitter 101 and the signal receiver 102 are designed in a matched manner, that is, the signal transmitter 101 is matched with the signal receiver 102 via a specific protocol, thereby solving the problem that the signal device is interfered by a general protocol or other protocols.

Embodiments of the present disclosure further provide a switch including the signal device according to any of embodiments of the present disclosure and a control module assembly 200, wherein a plug interface for receiving a portion of the signal receiver 102, such as a standard USB interface 201, is formed in the control module assembly, as described above.

A smart electronic switch may be obtained by assembling the signal device and control module assembly 200 on an internal functional component that may be arranged, for example, in a wall of a room. Such electronic switch mounted in the wall is fixed and involves complicated wiring of the circuit line in the wall. The switch is used at a relatively high frequency. The unique design of the separable and independent signal device according to embodiments of the present disclosure can avoid influences or limitations to wiring and installation of the switch. In particular, this avoids adverse effects on the life cycle of the entire switch which are caused by faults of the signal transmitter 101 and/or the signal receiver 102 of the signal device.

It should be appreciated that the foregoing description of the embodiments of the present disclosure is only intended to enable those skilled in the art to better understand and further implement the present disclosure, not to limit the extent of protection of the present disclosure in any manner. It should be noted that similar or identical reference numerals may be used in the figures where possible, and similar or identical reference numerals may represent similar or identical functions. Those skilled in the art will readily recognize that alternative embodiments of the structures and methods described herein may be employed without departing from the principles of the present disclosure described herein.

As used herein, the term “comprise” and its various variants may be understood to mean an open term, which means “including but not limited to”. The term “based on” may be understood to mean “based at least in part.” The term “an embodiment” may be understood to mean “at least one embodiment”. The term “another embodiment” may be understood to mean “at least one other embodiment”.

References to any prior art in this specification are not, and should not be construed as admitting or implying that these prior art constitute common knowledge.

It should be appreciated that the appended claims are only provisional claims, and are examples of possible claims, and are not intended to limit the scope of claims to any future patent application based on the present application. It is possible to add components to or delete components from example claims in the future to further limit or re-limit the present disclosure.

1. A signal device for a switch, comprising:
a signal transmitter disposed separately from the switch and configured to transmit a signal in response to a trigger; and
a signal receiver detachably coupled to the switch and configured to control an operation of the switch in response to the signal transmitted by the signal transmitter.

2. The signal device of claim 1, wherein a button or knob is provided on the signal transmitter, and the signal transmitter is configured to transmit the signal in response to the button or knob being operated.

3. The signal device of claim 1, wherein at least one surface of the signal transmitter comprises a touch-sensitive surface, and the signal transmitter is configured to transmit the signal in response to the touch-sensitive surface being touched.

4. The signal device of claim 1, wherein the signal transmitter is provided with at least one of the following to sense the trigger: a sound sensor, an optical sensor, a microwave sensor, a temperature sensor, a humidity sensor, a gas sensor, a touch sensor, a fingerprint recognition sensor, a voice recognition sensor and a camera.

5. The signal device of claim 4, wherein the optical sensor is an infrared sensor.

6. The signal device of claim 1, wherein the signal receiver is communicatively coupled to the switch via a standard USB interface formed on the switch.

7. A switch comprising:
the signal device of claim 1; and
a control module assembly comprising an interface for receiving a portion of the signal receiver.

8. The switch of claim 7, wherein the interface is a standard USB interface.
